(19) United States
(12) Patent Application Publication
(10) Pub. No.: US 2025/0063465 A1
(43) Pub. Date: Feb. 20, 2025

(54) SYSTEMS AND METHODS FOR SUPPORT OF MULTIPLE ACCESS PATHS

(71) Applicant: ZTE CORPORATION, Shenzhen (CN)

(72) Inventors: Xingyue ZHOU, Shenzhen (CN); Jinguo ZHU, Shenzhen (CN); Menghan WANG, Shenzhen (CN)

(73) Assignee: ZTE CORPORATION, Shenzhen (CN)

(21) Appl. No.: 18/936,613

(22) Filed: Nov. 4, 2024

Related U.S. Application Data
(63) Continuation of application No. PCT/CN2022/115915, filed on Aug. 30, 2022.

(51) Int. Cl. H04W 40/22; H04W 76/15; H04W 84/06; H04W 84/12

(52) U.S. Cl. CPC H04W 40/22; H04W 76/15; H04W 84/06; H04W 84/12

(57) ABSTRACT

Presented are systems and methods for support of multiple access paths. A wireless communication device may receive a route selection policy including a first indication from a core network. The wireless communication may establish a plurality of access paths to connect with the core network. The plurality of access paths may include two access paths that can be cellular-based. The wireless communication device may determine to establish the two cellular-based access paths according to the first indication.

### CROSS-REFERENCE TO RELATED APPLICATION

This application claims the benefit of priority under 35 U.S.C. § 120 as a continuation of International Patent Application No. PCT/CN2022/115915, filed on Aug. 30, 2022, the disclosure of which is incorporated herein by reference in its entirety.

### TECHNICAL FIELD

The disclosure relates generally to wireless communications, including but not limited to systems and methods for support of multiple access paths.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device (e.g., a user equipment (UE)) may receive a route selection policy (e.g., a URSP) including a first indication from a core network. The wireless communication device may establish a plurality of access paths to connect with the core network. The plurality of access paths may include two access paths that can be cellular-based. The wireless communication device may determine to establish the two cellular-based access paths (may include other access paths, in addition to the two 3GPP access paths) according to the first indication. The first indication may include a list of access paths from the plurality of access paths. The first indication may indicate a first access path of the plurality of access paths, via at least one of: an indication of a type of radio access technology (RAT), or an identification (ID) of a network.

In some embodiments, the wireless communication device may receive a traffic routing rule including a second indication that the wireless communication can be to route a first type of traffic via at least one specified access path of the plurality of access paths from the core network. The wireless communication device may determine to route first traffic of the first type via the at least one specified access path according to the second indication. The wireless communication device may determine that the first traffic is of the first type. The wireless communication device may determine that the traffic routing rule applies to the first traffic in response to the first traffic being of the first type. The second indication may indicate the specified access path via at least one of: an indication of a type of radio access technology (RAT), or an identification (ID) of a network.

In some embodiments, the type of RAT may include one of: whether the first access path is cellular-based; or long term evolution (LTE, new radio (NR), wireless locate area network (WLAN), bluetooth, or non-terrestrial network (NTN). In some embodiments, the ID of the network may comprise: an ID of a public land mobile network (PLMN), or an ID of a non-public network (NPN). The at least one specified access path may include at least one of: at least one of the two cellular-based access paths, or an access path that is not cellular-based.

In some embodiments, the at least one specified access path may include a first plurality of access paths. The second indication may indicate that a specific portion of traffic of the first type can be to be routed via a corresponding one of the first plurality of access paths.

In some embodiments, the wireless communication device may establish a connection to the core network via a first access path and a second access path, to access a same data service. The wireless communication device may receive the route selection policy via at least one of the first access path or the second access path. The wireless communication device may receive the traffic routing rule via at least one of the first access path or the second access path.

In some embodiments, the connection established to the network function may comprise a user plane connection. The wireless communication device may receive the route selection policy or the traffic routing rule via the connection established to the network function, using a protocol. The protocol may comprise at least one of: performance measurement function protocol (PMFP), multipath transmission control protocol (MPTCP), datagram congestion control protocol (DCCP), multipath quick user plane function internet connection (MPQUIC), simple two-way active measurement protocol (STAMP), or two-way active measurement protocol (TWAMP).

In some embodiments, a core network may send a route selection policy including a first indication to a wireless communication device. The wireless communication device may establish a plurality of access paths to connect with the core network. The plurality of access paths including two access paths that are cellular-based. The first indication may cause the wireless communication device to establish the two cellular-based access paths.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of multiple access paths, in accordance with some embodiments of the present disclosure;

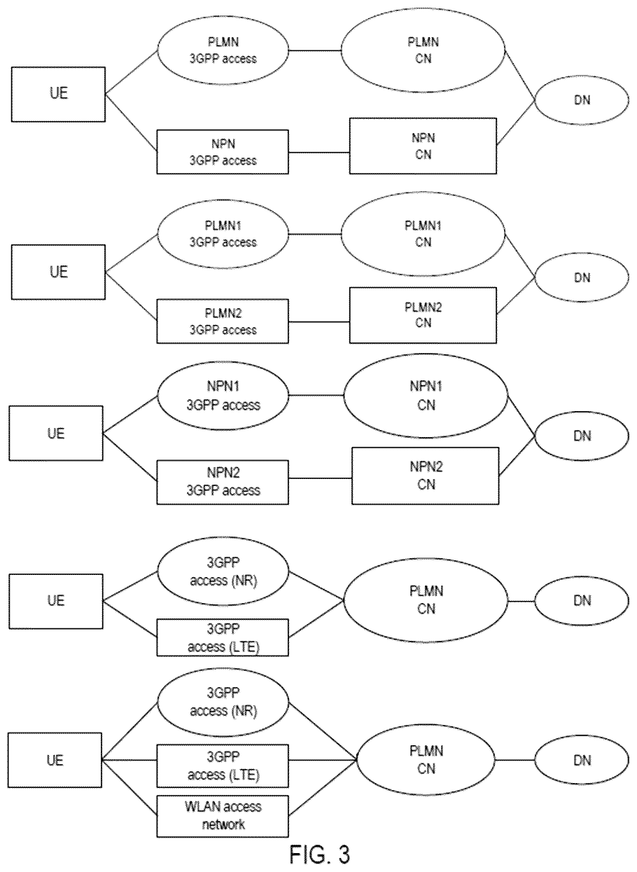

FIG. 4 illustrates a flow diagram of an example method for support of multiple access paths, in accordance with some embodiments of the present disclosure; and

FIG. 5 illustrates a flow diagram for support of multiple access paths, in accordance with an embodiment of the present disclosure.

### DETAILED DESCRIPTION

### 1. Mobile Communication Technology and Environment

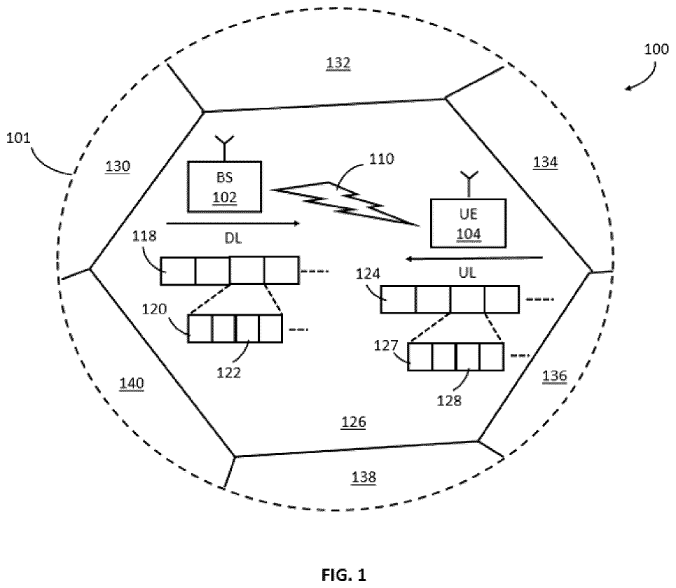

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

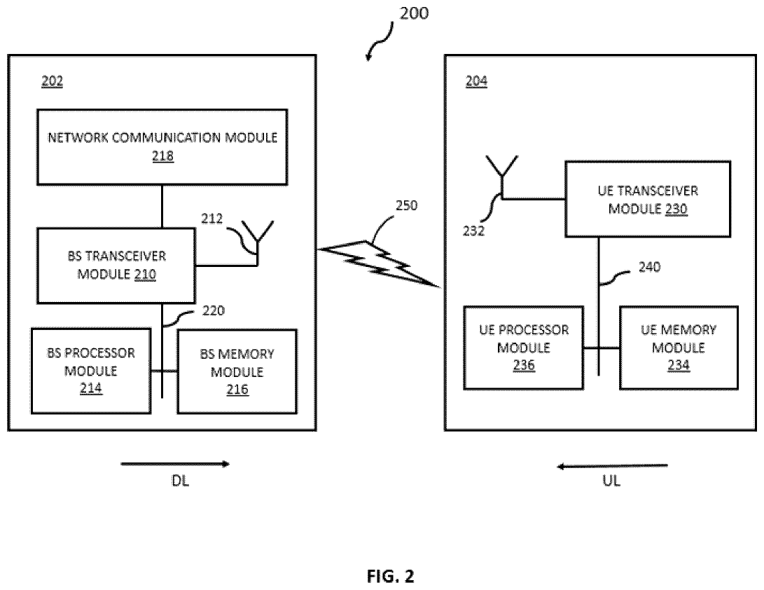

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Support of Multiple Access Paths

5G system (5GS) may support certain functionalities to provide multi-access data connectivity at upper layers (e.g., above radio access network (RAN)). The multi access data connectivity may include a possibility to exchange user-plane traffic between a user equipment (UE) and a data network by simultaneously using two access network paths, and/or two independent user plane tunnels between a RAN and an anchor user plane function in 5G core (5GC). For example, access traffic steering, switching and splitting (ATSSS) may support a traffic steering, a split and/or a switching across one 3GPP access path and one non-3GPP access path.

In some scenarios, it may be desired to distribute and/or aggregate a traffic across two 3GPP access paths, such as: (i) two 3GPP access paths in the same public land mobile network (PLMN) (e.g., one path using long-term evolution (LTE)/evolved packet core (EPC) and another path using new radio (NR)/5GC), or two paths using 3GPP non-terrestrial networks (NTN) access (e.g., over low earth orbit (LEO) and medium earth orbit (MEO)/geosynchronous earth orbit (GEO))); (ii) two 3GPP access paths over two different PLMNs, or between a PLMN and an non-public network (NPN) (e.g., one path using 3GPP NTN access via PLMN-1 and another path using 3GPP terrestrial access via PLMN-2 (or NPN), or two 3GPP terrestrial access paths using the same RAT (e.g., NR&NR, NTN&NTN) or different RATs (e.g., NR plus LTE)); or (iii) more than two access paths over different PLMNs, or between PLMN and NPN. With the requirements described above, how to indicate a UE to route through application traffics by a network in different ways is disclosed herein.

UE policies for 5GS may include at least one of: a UE route selection policy (URSP), an access network discovery and selection policy (ANDSP), a vehicle to everything (V2X) policy (V2XP), or 5G proximity services (ProSe) policy (ProSeP). The UE policies may notify/tell/inform the UE which access paths to use. In some embodiments, the UE policies can also be pre-configured in the UE. The UE policies can be delivered from a policy control function (PCF) to the UE. The pre-configured policy may be applied by the UE when the UE has not received the same type of policy from the PCF.

The URSP can be a set of one or more URSP rules. A URSP rule may comprise: (a) a precedence value of the URSP rule identifying the precedence of the URSP rule among all existing URSP rules; (b) a traffic descriptor, including either: (1) match-all traffic descriptor; or (2) at least one of following components: one or more application identifiers, one or more IP 3 tuples (e.g., a destination IP address, a destination port number, or a protocol in use above the IP), one or more non-IP descriptors (e.g., destination information of non-IP traffic), one or more data network names (DNNs), one or more connection capabilities, or one or more domain descriptors (e.g., destination fully qualified domain name(s) (FQDN(s)) or a regular expression as a domain name matching criteria; or (c) one or more route selection descriptors each including a precedence value of the route selection descriptor and (1) one power distribution unit (PDU) session type and, optionally, one or more of followings: a session and service continuity (SSC) mode, one or more single-network slice selection assistance information (S-NSSAI), one or more DNNs, a preferred access type, a multi-access preference, a time window, location criteria, a PDU session pair ID, or a robust security network (RSN), (2) non-seamless non-3GPP offload indication, (3) a 5G ProSe layer-3 UE-to-network relay offload indication.

In the route selection descriptor, “multi-access preference” can be used to recommend that the UE may establish a PDU session over multiple access networks. “Multi-access” can be interpreted as “one 3GPP access (path) and one non-3GPP access (path).” In some embodiments, the UE may use the PDU session over more than two access networks and not limited to one 3GPP access path and one non-3GPP access path.

The access traffic steering, switching and splitting (ATSSS) feature can be an optional feature that may be supported by the UE and the 5GC network. The ATSSS feature may enable a multi-access PDU connectivity service, which can exchange PDUs between the UE and a data network by simultaneously using one 3GPP access network and one non-3GPP access network and two independent N3/N9 tunnels between a PDU session anchor (PSA) and RAN/access network (AN). The multi-access PDU connectivity service can be realized by establishing a multi-access PDU (MA PDU) session (e.g., a PDU session that may have user-plane resources on two access networks), which assumes both 3GPP access and non-3GPP access are allowed for the S-NSSAI of the PDU session. The UE may request a MA PDU session when the UE is registered via both 3GPP and non-3GPP accesses, or when the UE is registered via one access only.

After the establishment of a MA PDU Session, and when there are user-plane resources on both access networks, the UE may apply network-provided policies (e.g., ATSSS rules) and may consider local conditions (e.g., a network interface availability, signal loss conditions, or user preferences) for deciding how to distribute the uplink traffic across the two access networks. Similarly, a user plane function (UPF) anchor of the MA PDU session may apply network-provided policies (e.g., N4 rules) and may feedback information received from the UE via a user-plane (e.g., access network unavailability or availability) for deciding how to distribute the downlink traffic across the two N3/N9 tunnels and two access networks. When there are user-plane resources on only one access network, the UE may apply the ATSSS rules and may consider local conditions for triggering an establishment or activation of user plane resources over another access.

### Implementation Example 1

This implementation example introduces a new indication in a UE route selection policy (URSP). The indication may indicate that the UE establishes a connection (e.g., a plurality of access paths) to a core network on at least one access path of a plurality of access paths. The indication can be a list. Each entry of the list may refer to an access path to the network. The plurality of access paths may include two access paths that are cellular-based (e.g., LTE or NR). In addition to the two access paths, the plurality of access paths may include other access paths (using a 3GPP access network or a non-3GPP access network). The entry can include at least one of: an indication of a type of radio access technology (RAT), or an identification (ID) of a network. With a development of the UE and/or 4G/5G/6G network deployments, the disclosure may bring more reliable band resources for the UE. The UE may use 4G/5G/6G radio resources to setup a communication connection with the network simultaneously.

The RAT type component may be represented with whether the access path is cellular-based (to indicate whether the responsible RAT is 3GPP or not); or long term evolution (LTE, new radio (NR), wireless locate area network (WLAN), bluetooth, or non-terrestrial network (NTN) (e.g., LEO, MEO, or GEO).

The network ID component may be represented by an identity which may uniquely identify the network (e.g., a globally unique ID). For example, the network ID component may comprise: an ID of a public land mobile network (PLMN), or an ID of a non-public network (NPN).

Following may include examples describing how the indication can be interpreted in the UE policy. (1) Indication a (NR; LTE): a connection can be established over a NR and a LTE to the network. (2) Indication b (Identifier of PLMN 1; Identifier of PLMN 2): a connection can be established through a PLMN 1 and a PLMN 2 simultaneously. (3) Indication c (Identifier of NPN 1; Identifier of PLMN 3): a connection can be established through a NPN 1 and a PLMN 3 simultaneously. (4) Indication d (LTE, Identifier of PLMN 4; NR, Identifier of PLMN 5): a connection can be established through a PLMN 4 over a LTE, and through a PLMN 5 over a NR simultaneously. (5) Indication e (NR, Identifier of NPN 2; LTE, Identifier of PLMN 6): a connection can be established through a NPN 2 over a NR, and through a PLMN 6 over a LTE simultaneously. (6) Indication f (NR, Identifier of NPN 3; NTN, Identifier of PLMN 7): a connection can be established through a NPN 3 over a NR, and through a PLMN 7 over a NTN simultaneously. (7) Indication g (NR; LTE; WLAN): a connection can be established over a NR, a LTE and a WLAN to the network simultaneously.

### Implementation Example 2

This implementation example introduces a new indication in an access traffic steering, switching and splitting (ATSSS) traffic routing rule. A UE may receive at least one traffic routing rule from a core network via a non-access stratum (NAS) signaling. The UE may determine an access path according to the at least one traffic routing rule. In some embodiments, the ATSSS traffic routing rule may be delivered to the UE after the UE sets up two access paths. An indication may indicate that the UE can be to route a related traffic on/via at least one specified access path of a plurality of access paths when the related traffic matches the at least one traffic routing rule. The indication may refer to an access path to the network. The indication may can include at least one of: an indication of a type of radio access technology (RAT), or an identification (ID) of a network.

The RAT type component may be represented with whether the access path is cellular-based (to indicate whether the responsible RAT is 3GPP or not); or long term evolution (LTE, new radio (NR), wireless locate area network (WLAN), bluetooth, or non-terrestrial network (NTN) (e.g., LEO, MEO, or GEO).

The network ID component may be represented by an identity which may uniquely identify the network (e.g., a globally unique ID). For example, the network ID component may comprise: an ID of a public land mobile network (PLMN), or an ID of a non-public network (NPN).

The present solutions provides for indicating different types of 3GPP or non-3GPP access. Following may include examples describing how a routing rule can be interpreted in the UE policy. (a) “Traffic Descriptor: UDP, DestAddr 1.2.3.4”, “Steering Mode: Active-Standby, Active=NR, Standby=LTE”: This rule may mean/indicate “steer UDP traffic (e.g., the type of traffic matched to the rule) with destination IP address 1.2.3.4 to the active access (NR), if available. If the active access is not available, the UE may use the standby access (LTE). (b) “Traffic Descriptor: Application-1”, “Steering Mode: Load-Balancing, PLMN 1=20%, PLMN 2-80%”, “Steering Functionality: MPTCP”: This rule may mean/indicate “send 20% of the traffic of Application-1 through PLMN 1 and 80% through PLMN 2 by using the MPTCP functionality.” PLMN 1 may represent an identifier of PLMN 1. (c) “Traffic Descriptor: Application-1”, “Steering Mode: Load-Balancing, NPN 1=20%, PLMN 3-80%”, “Steering Functionality: MPTCP”: This rule may mean/indicate “send 20% of the traffic of Application-1 through NPN 1 and 80% through PLMN 3 by using the MPTCP functionality.” NPN 1 may represent an identifier of NPN 1. (d) “Traffic Descriptor: Application-1”, “Steering Mode: Load-Balancing, NR NPN 2=20%, NTN PLMN 4-80%”, “Steering Functionality: MPTCP”: This rule may mean/indicate “send 20% of the traffic of Application-1 through NPN 2 over NR and 80% through PLMN 4 over NTN by using the MPTCP functionality.” (c) “Traffic Descriptor: Application-2”, “Steering Mode: Load-Balancing, LTE=20%, NR 2-60%”, WLAN=20% “Steering Functionality: MPTCP”: This rule may mean/indicate “send 20% of the traffic of Application-1 through LTE, 60% through NR2, and 20% through WLAN by using the MPTCP functionality.”

### Implementation Example 3

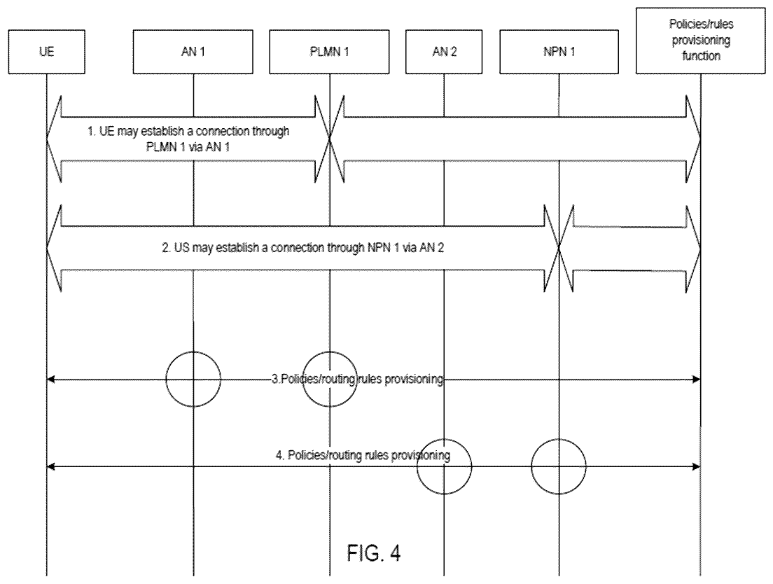

This implementation example describes a procedure (in FIG. 4) of a UE obtaining traffic routing rules over user planes which can be established via multiple access paths.

In steps 1-2, a UE may establish/register a connection (#1) through a public land mobile network 1 (PLMN 1) via an access network 1 (AN 1) and/or a connection (#2) through a NPN 1 via an AN 2, respectively. The connection #1 and connection #2 have at least one common connection attributes (e.g., a data network name (DNN), single-network slice selection assistance information (S-NSSAI), or a transport protocol type) which supports the UE to access same data service.

In steps 3-4, upon completion of the discovery and the selection of the network function (NF) provisioning UE policies and/or traffic routing rules, the UE may establish a communication connection with the NF. The communication connection can be established to the NF through either PLMN 1, NPN 1 or both. The communication connection may be any type of protocol signaling connection. The NF may use the communication connection on either access path to deliver a route selection related policy and/or routing rules to the UE. The UE can send a request related with the route selection related policy and/or routing rules to the NF with the communication connection on either access path. The route selection related policy and/or routing rules may include the indication described in implementation example 1 and implementation example 2.

Following may include examples of protocol signaling connection for the communication connection between the UE and the NF: (a) performance measurement function protocol (PMFP), (b) multipath transmission control protocol (MPTCP), (c) datagram congestion control protocol (DCCP), (d) multipath quick user plane function internet connection (MPQUIC), (c) simple two-way active measurement protocol (STAMP), or (f) a two-way active measurement protocol (TWAMP).

Support multiple access paths are considered as a direct and effective way to meet service requirements for an ultra-low latency, a high throughput, and/or a flow management. It should be understood that one or more features from the above implementation examples are not exclusive to the specific implementation examples, but can be combined in any manner (e.g., in any priority and/or order, concurrently or otherwise).

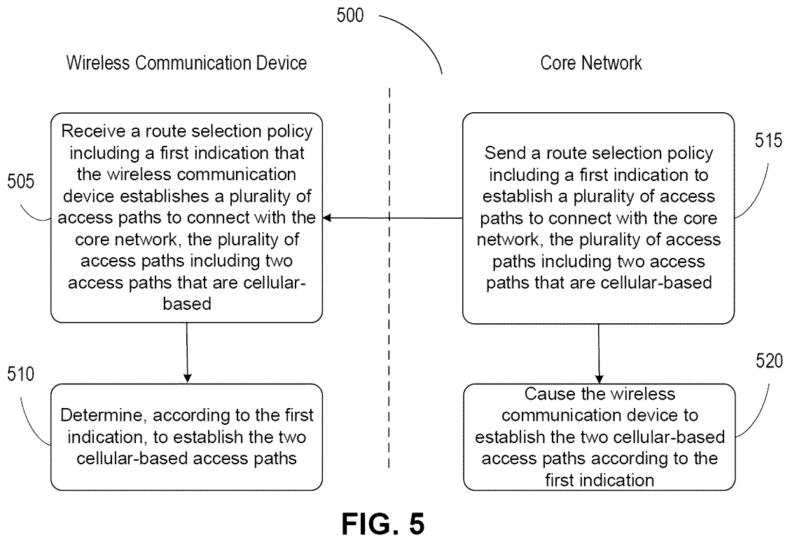

FIG. 5 illustrates a flow diagram of a method 500 for support of multiple access paths. The method 500 may be implemented using any one or more of the components and devices detailed herein in conjunction with FIGS. 1-2. In overview, the method 500 may be performed by a wireless communication device, in some embodiments. Additional, fewer, or different operations may be performed in the method 500 depending on the embodiment. At least one aspect of the operations is directed to a system, method, apparatus, or a computer-readable medium.

A wireless communication device (e.g., a user equipment (UE)) may receive a route selection policy (e.g., a URSP) including a first indication from a core network. The wireless communication device may establish a plurality of access paths to connect with the core network. The plurality of access paths may include two access paths that can be cellular-based (may include other access paths, in addition to the two 3GPP access paths). The wireless communication device may determine to establish the two cellular-based access paths according to the first indication. The first indication may include a list of access paths from the plurality of access paths. The first indication may indicate a first access path of the plurality of access paths, via at least one of: an indication of a type of radio access technology (RAT), or an identification (ID) of a network.

In some embodiments, the wireless communication device may receive a traffic routing rule including a second indication that the wireless communication can be to route a first type of traffic via at least one specified access path of the plurality of access paths from the core network. The wireless communication device may determine to route first traffic of the first type via the at least one specified access path according to the second indication. The wireless communication device may determine that the first traffic is of the first type. The wireless communication device may determine that the traffic routing rule applies to the first traffic in response to the first traffic being of the first type. The second indication may indicate the specified access path via at least one of: an indication of a type of radio access technology (RAT), or an identification (ID) of a network.

In some embodiments, the type of RAT may include one of: whether the first access path is cellular-based; or long term evolution (LTE, new radio (NR), wireless locate area network (WLAN), bluetooth, or non-terrestrial network (NTN). In some embodiments, the ID of the network may comprise: an ID of a public land mobile network (PLMN), or an ID of a non-public network (NPN). The at least one specified access path may include at least one of: at least one of the two cellular-based access paths, or an access path that is not cellular-based.

In some embodiments, the at least one specified access path may include a first plurality of access paths. The second indication may indicate that a specific portion of traffic of the first type can be to be routed via a corresponding one of the first plurality of access paths.

In some embodiments, the wireless communication device may establish a connection to the core network via a first access path and a second access path, to access a same data service. The wireless communication device may receive the route selection policy via at least one of the first access path or the second access path. The wireless communication device may receive the traffic routing rule via at least one of the first access path or the second access path.

In some embodiments, the connection established to the network function may comprise a user plane connection. The wireless communication device may receive the route selection policy or the traffic routing rule via the connection established to the network function, using a protocol. The protocol may comprise at least one of: performance measurement function protocol (PMFP), multipath transmission control protocol (MPTCP), datagram congestion control protocol (DCCP), multipath quick user plane function internet connection (MPQUIC), simple two-way active measurement protocol (STAMP), or two-way active measurement protocol (TWAMP).

In some embodiments, a core network may send a route selection policy including a first indication to a wireless communication device. The wireless communication device may establish a plurality of access paths to connect with the core network. The plurality of access paths including two access paths that are cellular-based. The first indication may cause the wireless communication device to establish the two cellular-based access paths.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
receiving, by a wireless communication device from a core network, a route selection policy including a first indication that the wireless communication device establishes a plurality of access paths to connect with the core network, the plurality of access paths including two access paths that are cellular-based; and
determining, by the wireless communication device according to the first indication, to establish the two cellular-based access paths.

2. The method of claim 1, wherein the first indication includes a list of access paths from the plurality of access paths.

3. The method of claim 1, wherein the first indication indicates a first access path of the plurality of access paths, via at least one of: an indication of a type of radio access technology (RAT), or an identification (ID) of a network.

4. The method of claim 1, comprising:
receiving, by the wireless communication device from the core network, a traffic routing rule including a second indication that the wireless communication is to route a first type of traffic via at least one specified access path of the plurality of access paths; and
determining, by the wireless communication device according to the second indication, to route first traffic of the first type via the at least one specified access path.

5. The method of claim 4, comprising:
determining, by the wireless communication device, that the first traffic is of the first type; and
determining, by the wireless communication device responsive to the first traffic being of the first type, that the traffic routing rule applies to the first traffic.

6. The method of claim 4, wherein the second indication indicates the specified access path via at least one of: an indication of a type of radio access technology (RAT), or an identification (ID) of a network.

7. The method of claim 3, wherein the type of RAT includes one of:
whether the first access path is cellular-based; or
long term evolution (LTE), new radio (NR), wireless locate area network (WLAN), bluetooth, or non-terrestrial network (NTN).

8. The method of claim 3, wherein the ID of the network comprises:
an ID of a public land mobile network (PLMN), or
a ID of a non-public network (NPN).

9. The method of claim 4, wherein the at least one specified access path includes at least one of:
at least one of the two cellular-based access paths, or
an access path that is not cellular-based.

10. The method of claim 4, wherein the at least one specified access path includes a first plurality of access paths, and the second indication indicates that a specific portion of traffic of the first type is to be routed via a corresponding one of the first plurality of access paths.

11. The method of claim 1, comprising:
establishing, by the wireless communication device, a connection to the core network via a first access path and a second access path, to access a same data service; and
establishing, by the wireless communication device, a connection to a network function (NF) via at least one of the first access path or the second access path.

12. The method of claim 11, comprising:
receiving, by the wireless communication device via at least one of the first access path or the second access path, the route selection policy.

13. The method of claim 11, comprising:
receiving, by the wireless communication device via at least one of the first access path or the second access path, the traffic routing rule.

14. The method of claim 12, wherein the connection established to the network function comprises a user plane connection.

15. The method of claim 12, comprising receiving the route selection policy or the traffic routing rule via the connection established to the network function, using a protocol comprising at least one of:
performance measurement function protocol (PMFP),
multipath transmission control protocol (MPTCP),
datagram congestion control protocol (DCCP),
multipath quick user plane function internet connection (MPQUIC),
simple two-way active measurement protocol (STAMP), or
two-way active measurement protocol (TWAMP).

16. A method, comprising:
sending, by a core network to a wireless communication device, a route selection policy including a first indication to the wireless communication device, to establish a plurality of access paths to connect with the core network, the plurality of access paths including two access paths that are cellular-based; and
causing the wireless communication device to establish the two cellular-based access paths according to the first indication.

17. A wireless communication device, comprising:
at least one processor configured to:
receive, via a receiver from a core network, a route selection policy including a first indication that the wireless communication device establishes a plurality of access paths to connect with the core network, the plurality of access paths including two access paths that are cellular-based; and
determine, according to the first indication, to establish the two cellular-based access paths.

18. A core network node, comprising:
at least one processor configured to:
send, via a transmitter to a wireless communication device, a route selection policy including a first indication to the wireless communication device, to establish a plurality of access paths to connect with the core network, the plurality of access paths including two access paths that are cellular-based; and
cause the wireless communication device to establish the two cellular-based access paths according to the first indication.

19. The core network node of claim 18, wherein the first indication includes a list of access paths from the plurality of access paths.

20. The core network node of claim 18, wherein the first indication indicates a first access path of the plurality of access paths, via at least one of: an indication of a type of radio access technology (RAT), or an identification (ID) of a network.
